(19) United States
(12) Patent Application Publication
(10) Pub. No.: US 2017/0348651 A1
(43) Pub. Date: Dec. 7, 2017

(54) MIXING/DISPERSING APPARATUS AND METHOD

(71) Applicant: Wakana KAIZUKA, Hachioji-shi, Tokyo (JP)

(72) Inventor: Wakana KAIZUKA, Hachioji-shi, Tokyo (JP)

(21) Appl. No.: 15/538,456

(22) PCT Filed: Jan. 4, 2016
(86) PCT No.: PCT/JP2016/050012

§ 371 Date: Jun. 21, 2017

(30) Foreign Application Priority Data
Dec. 29, 2014 (JP) 2014-267035

(51) Int. Cl. B01F 5/06; B01F 3/10; B01F 3/12; B01F 15/02; B01F 5/00

(52) U.S. Cl. CPC B01F 5/0644; B01F 3/12; B01F 15/0243; B01F 3/10; B01F 2215/0014; B01F 2215/0431; B01F 2215/0468; B01F 2005/0025

(57) ABSTRACT

The apparatus can produce a product highly mixed and dispersed to a quasi-perfect level in a short time and has an extremely simple arrangement to reduce the processing cost. The mixing/dispersing apparatus for a liquid/liquid mixture includes an elongated thin tube into which the liquid/liquid mixture flows, an inlet provided at one end of the elongated thin tube to receive the liquid/liquid mixture, an outlet provided at the other end to discharge the liquid/liquid mixture, and a mixture pumping device for allowing the mixture to be fed under pressure into the elongated thin tube at a flow rate exceeding a critical Reynolds number. Two liquid storage boxes are provided such that one is located before the inlet provided at one end of the elongated thin tube and the other is located after the outlet, and a plurality of elongated thin tubes is provided between the liquid storage boxes.

### FIELD OF THE INVENTION

The present invention relates to an apparatus for mixing and dispersing a multi-phase material in general and a liquid/liquid material or liquid/fine solid material in particular as well as a mixing/dispersing method.

### BACKGROUND OF THE INVENTION

So far products comprising mixtures of various materials have been used in every industrial field.

These days the comparative merits and demerits of products are primarily determined and evaluated by the degrees of mixing and dispersion of such mixtures.

In other words, there is now mounting demand for technology capable of mixing and dispersing a multi-phase mixture such as liquid/liquid, liquid/solid, liquid/air mixtures up to a quasi-perfect level.

Conventional mixing/dispersing means have made use of stirring blades or ultrasonic waves.

However, mixing by stirring blades fails to produce large shearing force due to an increasing number of laminar components; hence, its mixing efficiency is not that high given the applied energy. In addition, much stirring time is taken because the stirring effect varies within a stirring tank due to the fact that the stirring action is proportional to distances from the stirring blades.

Ultrasonic mixing takes place through cavitations obtained by microscopic pressure fluctuations in a liquid; however, continued mixing over an extended period of time is impossible because the stirring effect varies within a mixing apparatus due to the fact that the magnitude of vibration energy varies depending on the distance and direction from an ultrasonic vibration device, and there is a risk of the juncture of the vibration device suffering from wearing.

### SUMMARY OF THE INVENTION

### Problems with the Prior Art

With the prior art as described above, it is impossible to obtain a mixed/dispersed product in which a mixture having an imperfect mixing degree can be brought up to a quasi-perfect mixing/dispersion level for a short period of time.

An apparatus having a simplified arrangement capable of mixing and dispersing a mixture to a high level yet at low costs is not achieved either.

### Embodiments of the Invention

To provide a solution to the aforesaid problems, the present invention provides an apparatus and method for producing a combined mixed and dispersed product, as described in the following claims.

### Advantages of the Invention

According to the present invention, it is possible to produce a quasi-perfect, highly mixed and dispersed product in a time as short as possible, and the apparatus for it is very simplified in construction and, hence, expensive to assemble. According to the invention, the apparatus and processing costs are 4/1 or lower than the usual costs.

### BRIEF EXPLANATION OF THE DRAWINGS

FIG. 1 is illustrative in construction of the apparatus for producing a mixed and dispersed product according to the invention.

FIG. 2 is illustrative in appearance of an elongated, thin tube built in the apparatus of the invention.

### MODES FOR CARRYING OUT THE INVENTION

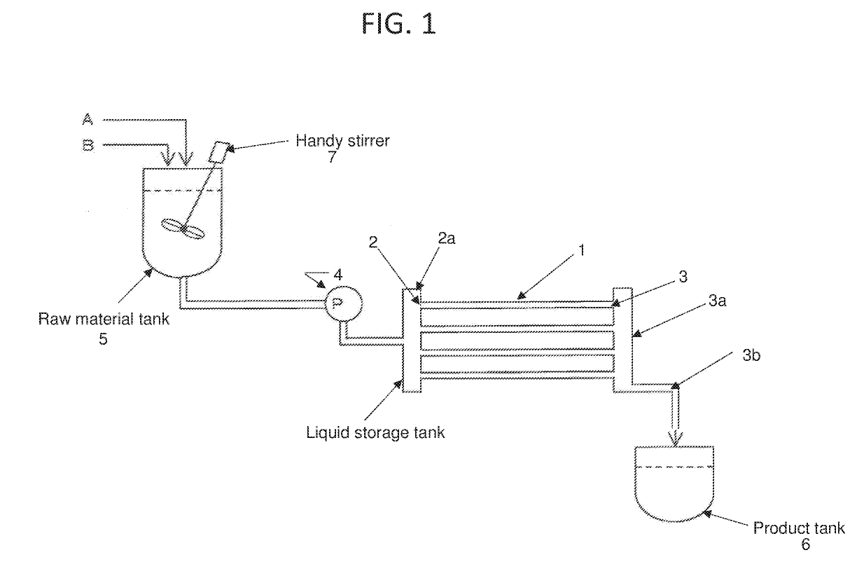

The mixing/dispersing apparatus used herein is made up as shown typically in FIG. 1 in which reference numeral 1 stands for an elongated thin tube, 2 a mixture inlet, 2a an inlet-side liquid storage box, 3 an outlet out of which a mixed and dispersed liquid is discharged, 3a an inlet-side liquid storage box, 3b a dispenser port, 4(P) a pump, 5 a raw material tank, 6 a product storage tank, and 7 a handy stirrer. Note here that A charged into the raw material tank 5 is water as an example and B is powdered soybean as an example.

Typically, the apparatus described herein may be made up of an elongated thin tube 1 into which a liquid/liquid mixture flows, an inlet 2 that is provided at one end of the thin tube 1 to receive that mixture, an outlet 3a that is provided at the other end to discharge the mixture, and a means 4(P) that feeds the mixture under pressure into the thin tube 1 at a flow rate exceeding a critical Reynolds number.

Preferably, two liquid storage boxes 2a and 3a, each in a thin box shape, are provided: one located before the mixture inlet 2 provided at one end of the thin tube 1 and the other located after the mixture outlet 3, and there are a plurality of elongated thin tubes . . . provided between both the liquid storage boxes.

A mixture fed from the pump 4(P) is temporarily stored in the liquid storage box from which the mixture is distributed into the plurality of thin tubes . . . under uniform pressure. Through each thin tube 1, the mixture flows at a flow rate exceeding a critical Reynolds number and travels a constant distance while creating turbulence. Thus, the highly mixed and dispersed product is fed through the liquid storage box 3a into the product tank 6 for storage.

It is here preferable that the elongated thin tube 1 has an inner diameter of 0.5 to 5.0 mm and a length of 100 to 1,000 mm and the pressure under which the mixture is fed into the mixture inlet is 0.5 to 10 MPa. The mixture is highly mixed and dispersed in the process of flowing through the thin tube.

The thin tube is preferably formed of a metal in general, and stainless steel, ceramics, rubber or plastic material in particular. A metallic or plastic tube may then be fitted over the ceramic thin tube to enhance its strength.

The outside configuration of the elongated thin tube may have a straight tube form, a loop tube form or a helical tube form with a circular, oval, triangular or polygonal section.

For the pump use may be made of a plunger pump or other liquid delivery pump.

Further, the elongated thin tube 1 is provided on its inlet side with a thin box form of liquid storage box 2a, and a mixture fed and stored once under pressure in that box is uniformly distributed and fed under pressure into the plurality of thin tubes 1 . . . .

The mixture fed into the thin tube 1 is mixed and dispersed to a high degree at a flow rate exceeding the critical Reynolds number.

### EXAMPLES

The present invention will now be explained with reference to some examples.

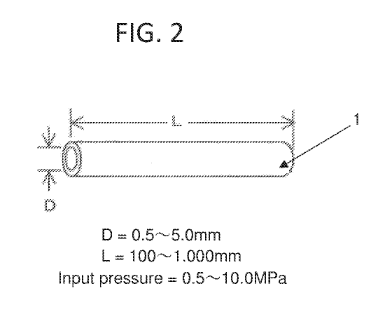

Using the apparatus shown in FIGS. 1 and 2, mixed and dispersed products of high quality, comprising various mixtures, were produced.

### Example 1: Example of Water/Skim Milk/Butter (Production of Manmade Milk)

Charged into the raw material tank 5 were 3200 ml of water, 600 grams of skim milk powder and 200 grams of butter, and they were heated to 50° C. and just simply stirred by means of the handy stirrer 7.

Then, the liquid mixture within the raw material tank 5 was supplied to the plunger pump 4(P) where it was pressurized, and then fed under an inlet pressure of 0.8 MPa into the elongated thin tube 1 of stainless steel via the inlet-side liquid storage box 2a.

It is here to be noted that the elongated thin tube had an inner diameter of 2.0 mm, a wall thickness of 1.0 mm and a length of 400 mm, and four such thin tubes were provided between the liquid storage boxes 2a and 3a.

In the thin tube 1, the mixture was highly mixed and dispersed by turbulence, and discharged out of the dispenser port 3b via the outlet-side liquid storage box 31 for storage.

In this case, the elongated thin tube 1 was vibrated under the influence of turbulence in a high noise level.

The resulting product was found to be equivalent in quality to commercially available milk.

More specifically, the product was found to have uniformly dispersed oily particles of 0.6 to 0.8 μm and a milk white appearance similar to commercially available milk, and had the same taste as commercially available milk.

It is here to be noted that a pressure of about 30 MPa is required for conventional manmade milk production (homogenizer).

### Example 2: Example of Multilayered Carbon Nanotube/Water (Production of a Carbon Nanotubes Dispersion)

Charged into the raw material tank were 5 grams of multilayered carbon nanotubes and 95 ml of water, and they were just simply stirred by means of the handy stirrer 7.

Then, the liquid mixture within the raw material tank 5 was supplied to the plunger pump 4(P) where it was pressurized, and then fed under an inlet pressure of 0.8 MPa into one elongated thin tube 1 via the inlet-side liquid storage box 2a.

It is here noted that the elongated thin tube of stainless steel had an inner diameter of 2.0 mm, a wall thickness of 1.0 mm and a length of 400 mm.

Through the thin tube 1 the mixture was highly mixed and dispersed by turbulence, and discharged from the dispenser port 3b via the outlet-side liquid storage box 3a into the product tank 6 for storage.

The resultant product was obtained in a mayonnaise state where there was thickening found, characteristic of a good carbon nanotubes dispersion.

### Example 3: Example of Production of a Glycerin Dispersion

One hundred (100) ml of glycerin having a viscosity of 1.4 Pa-s was charged into the raw material tank 5 shown in FIG. 1, and just simply mixed by means of the handy stirrer 7.

Then, the glycerin within the raw material tank 5 was supplied to the plunger pump 4(P) where it was pressurized, and then fed under an inlet pressure of 0.8 MPa into one elongated thin tube 1 via the inlet-side liquid storage box 2a.

It is here to be noted that the elongated thin tube 1 had an inner diameter of 2.0 mm, a wall thickness of 1.0 mm and a length of 400 mm.

The glycerin was highly mixed and dispersed in the thin tube, and a glycerin dispersion product was discharged out of the dispenser port 3b via the outlet-side liquid storage box 3a into the product tank 6 for storage.

As a result, it was found that the dispersion product after passed once through the tube had a viscosity of 0.7 Pa-s and the dispersion product after passed twice had a viscosity of 0.5 Pa-s.

Referring to a change-with-time in the product, the product was found to have the same viscosity as measured after four days, indicating the stability of the glycerin dispersion product. However, this lowering of viscosity has yet to be clarified. One possible reason is that a glycerin cluster would be divided and reduced by strong mixing/dispersing operation.

### EXPLANATION OF THE REFERENCE NUMERALS

1: Elongated thin tube
2: Mixture inlet
2a: Inlet-side liquid storage box
3: Outlet for the mixed and dispersed product
3b: Dispenser port
4(P): Pump
5: Raw material tank
6: Product storage tank
7: Handy stirrer

1. An apparatus for mixing and dispersing a multi-phase mixture, comprising an elongated thin tube into which said multi-phase mixture flows, an inlet that is provided at one end of the elongated thin tube to receive said multi-phase mixture, an outlet that is provided at the other end to discharge said multi-phase mixture, and a mixture pumping means for allowing said multi-phase mixture to be fed under pressure into said elongated thin tube at a flow rate exceeding a critical Reynolds number.

2. An apparatus for mixing and dispersing a liquid/liquid mixture, comprising an elongated thin tube into which said liquid/liquid mixture flows, an inlet that is provided at one end of the elongated thin tube to receive said liquid/liquid mixture, an outlet that is provided at the other end to discharge said liquid/liquid mixture, and a mixture pumping means for allowing said liquid/liquid mixture to be fed under pressure into said elongated thin tube at a flow rate exceeding a critical Reynolds number.

3. An apparatus for mixing and dispersing a liquid/fine solid mixture, comprising an elongated thin tube into which said liquid/fine solid mixture flows, an inlet that is provided at one end of the elongated thin tube to receive said liquid/fine solid mixture, an outlet that is provided at the other end to discharge said liquid/fine solid mixture, and a mixture pumping means for allowing said liquid/fine solid mixture to be fed under pressure into said elongated thin tube at a flow rate exceeding a critical Reynolds number.

4. The mixing/dispersing apparatus according to claim 1, wherein liquid storage boxes are provided, one located before said outlet provided at one end of said elongated thin tube and the other located after said outlet, and a plurality of elongated thin tubes is provided between both the liquid storage boxes.

5. The mixing/dispersing apparatus according to claim 1, wherein said elongated thin tube has an inner diameter of 0.5 to 5.0 mm and a length of 100 to 1,000 mm, and a pressure under which said mixture is fed into said inlet is 0.5 to 10 MPa.

6. The mixing/dispersing apparatus according to claim 2, wherein said liquid is a sol or a gel.

7. The mixing/dispersing apparatus according to claim 2, wherein said liquid is one or more or two selected from the group consisting of water, an aqueous solution, an organic solvent such as including an alcohol, glycerin, an oil, cocking oil, petroleum, heavy oil and silicone oil or fruit juice.

8. The mixing/dispersing apparatus according to claim 3, wherein said fine solid is a fine inorganic material or a fine organic material.

9. The mixing/dispersing apparatus according to claim 8, wherein said fine solid is one or two or more selected from the group consisting of a fine ceramics, a fine metal, a fine resin, fine foodstuff, fine carbon, fine soybean powder or skim milk powder.

10. A method for producing a multi-phase mixed/dispersed product, wherein a multi-phase mixture is fed under pressure into an elongated thin tube from its one end at a flow rate exceeding a critical Reynolds number, and then discharged out of the other end of said thin tube to obtain a highly mixed and dispersed mixture.

11. A method for producing a highly mixed and dispersed liquid/liquid product, wherein a liquid/liquid mixture is fed under pressure into an elongated thin tube from its one end at a flow rate exceeding a critical Reynolds number, and then discharged out of the other end of said thin tube to obtain a highly mixed and dispersed liquid/liquid mixture.

12. A method for producing a highly mixed and dispersed liquid/fine solid product, wherein a liquid/fine solid mixture is fed under pressure into an elongated thin tube from its one end at a flow rate exceeding a critical Reynolds number, and then discharged out of the other end of said thin tube to obtain a highly mixed and dispersed liquid/fine solid mixture.

13. A method for producing a mixed and dispersed product, wherein two liquid storage boxes are provided: one located before a mixture inlet located at one end of an elongated thin tube and the other located after a mixture outlet, and a plurality of elongated thin tubes is provided between both said liquid storage boxes, wherein a mixture is fed under pressure into said elongated thin tube from its one end at a flow rate exceeding a critical Reynolds number, and then discharged out of the other end of said thin tube.

14. The method for producing a mixed and dispersed product according to claim 10, wherein said elongated thin tube has an inner diameter of 0.5 to 5.0 mm and a length of 100 to 1,000 mm, and a pressure under which said mixture is fed into said inlet is 0.5 to 10 MPa.

15. The method for producing a mixed and dispersed product according to claim 11, wherein said liquid is a sol or a gel.

16. The method for producing a mixed and dispersed product according to claim 11, wherein said liquid is an inorganic material or an organic material.

17. The method for producing a mixed and dispersed product according to claim 12, wherein said fine solid is a fine inorganic material or a fine organic material.

18. The method for producing a mixed and dispersed product according to claim 17, wherein said fine solid is one or two or more selected from the group consisting of a fine ceramics, a fine metal, a fine resin, fine foodstuff, fine carbon, fine soybean powder or skim milk powder.

19. The method for producing a mixed and dispersed product according to claim 11, wherein said liquid is one or two or more selected from the group consisting of water, an aqueous solution, an organic solvent including an alcohol, glycerin, an oil, cocking oil, petroleum, heavy oil and silicone oil or fruit juice.
